(19) United States
(12) Patent Application Publication
(10) Pub. No.: US 2014/0045165 A1
(43) Pub. Date: Feb. 13, 2014

(54) METHODS AND APPARATUS FOR TRAINING PEOPLE ON THE USE OF SENTIMENT AND PREDICTIVE CAPABILITIES RESULTING THEREFROM

(71) Applicant: Aaron Showers, Plymouth, MI (US)

(72) Inventor: Aaron Showers, Plymouth, MI (US)

(21) Appl. No.: 13/584,783

(22) Filed: Aug. 13, 2012

(51) Int. Cl. G09B 7/00

(52) U.S. Cl. 434/362

(57) ABSTRACT

The present invention is an apparatus and method to (1) repetitively measure individual Sentiment; (2) aggregate all of the individual Sentiments into a collective Sentiment; (3) correlate the sentiment data versus a pre-defined dependent variable, such as what direction an individual stock's price is heading; (4) present the data to the end-users; (5) encourage repetitive use; (6) identify end-users who best predict future behavior of the dependent variable(s); and (7) improve the end-user's Sentiment accuracy with repetitive use.

### FIELD OF INVENTION

This invention relates to the fields of subjective measurement and predictive analysis. Specifically, this invention relates to the fields of measuring individual sentiment and identifying individuals whose sentiment predict, with ample correlation, the outcome of complex events like the movement of financial indices and individual stock prices. Alternately, this invention relates to the field of training a person so that their sentiment is correlated with one or more desired outcomes, and the use of trained sentiment users in order to create accurate, aggregate predictive capability.

### BACKGROUND OF INVENTION

Currently, many fields or topics of human endeavor do not lend themselves to accurate measurement and prediction. These types of endeavors typically create a fertile ground for so-called experts to sell their opinion, even when their opinion may not be accurate, or in worst case, may be catastrophically inaccurate.

Examples of such fields of endeavor include, but are not limited to, financial markets, political polling, litigation, product development, restaurant development, and movie development. On the internet, one can find literally thousands of financial advisors, bankers, brokers, and various middle-men willing to give their opinion on almost any issue, from which stock to purchase to whether gold is currently a good investment. The accuracy of these experts ranges from purely random (meaning that the expert is no more likely correct than random chance to correctly predict an outcome) to slightly helpful. Even when an expert's advice has been historically correct, it is often difficult to trust that their next decision will in fact be correct. As the book BLACK SWAN so ably demonstrated, past accuracy concerning the behavior or direction of the stock market is no guarantee of future performance. In fact, many advertisements for financial planners, advisors, and brokers drive this point home with a similarly worded disclaimer.

The entire financial industry relies on sophisticated mathematical algorithms that try to find past patterns in objective data, such as price-to-earnings ratios, derivatives of stock price, shoulder patterns, etc., to predict the future outcome of stock prices. These objective measurements have never seamlessly correlated to stock-prices, always leaving the user subject to a large, unpleasant surprise (e.g., the crashes of 1929, 1932, 1987, the tech bubble, 2008, etc.). Clearly, the current methods used by the financial industry, by themselves, yield poor results in the long-term.

In a similar manner, on the internet and TV, consumers are inundated with political pundits holding forth on the likely outcome of the next election. These pundits are often extolling the results of very expensive and labor intensive polling efforts, which have proven, repeatedly, to be subject to bias and other influences negating their predictive accuracy. The resulting polls often have confidence intervals which exceed the expected spread in the election.

Other fields of endeavor, like product development pose similar risks. In many companies, marketing experts are hired, either permanently, or on an ad hoc basis, to determine which products should be funneled into the development process. Often, in product development, the issue with a product is often not technical, but rather market-related. From the Pontiac Aztec to early Personal Digital Assistants and Beta-max-formatted video tape, the problem with a product that is technologically robust is often one of aesthetics, utility, or imagination. The ability of marketing experts to predict success in such conditions is pseudo-random and uncorrelated. Nonetheless, companies large and small spend millions of dollars per annum seeking out and following such advice.

Even litigation, an endeavor that is seeking truth, is rife with examples where expert prediction is unreliable.

These fields of endeavor all exhibit some of the same characteristics. They all, in the end, rely on the opinions, desires, likes and dislikes of large aggregations of the population. The aggregations of population are all substantial enough that single actors are unable to impact the results. All of these endeavors have a sufficiently large number of variables that make it is statistically impractical to attempt to cross-correlate them to any given output. Many exhibit forward feedback, or fractal, behavior, meaning that accurate prediction of future events is mathematically improbable. All of these endeavors vary over both short and long time horizons. All of these endeavors have output variables which are relatively easy to measure (e.g., stock price, election results, new product market-share, etc.). All of the output results are easily converted to a binary outcome (e.g., did the stock price go up, did the candidate win, did the market accept the product, etc.).

As society becomes more textured and complex, the number of fields of endeavors which share these characteristics will increase. Additionally, existing fields will become even more difficult to analyze. For example, financial derivatives, such as credit default swaps, can affect financial markets in a range from miniscule to catastrophic. This type of range is unhelpful, when trying to determine the course of future events. As a result, meaningful predictions from experts will tend to become worse, in the aggregate, in the near term, not better.

All of these fields of endeavor rely on individuals making decisions, some rational, some semi-rational, some irrational, some unconscious. These decisions are largely subjective. A person has a “feel” that the result they are giving is right. They assess data and try to vindicate their gut feeling, but in the end, most of the decision making process is highly subjective. This is true, whether it is the selection of a stock, the voting for a given candidate, or the selection of a particular product for the development process. In the end, this gets to the central proposition in ZEN AND THE ART OF MOTORCYCLE MAINTENANCE, that people cannot define a high quality solution, but they can recognize it when they see it. In this context, quality is not used as a mere synonym for reliability, but rather as a descriptor of a state in which the end users expectations are exceeded by the collection of attributes embodied by the solution.

Let's examine the financial field, briefly. The direction a stock moves, both on a given day, and over a week or a month, depends on the aggregate decisions of thousands of actors. Each individual actor possesses varying amounts of information concerning the transaction, such as historical price, future plans of the company, general stock market tendencies in the recent past, historical return on investment, etc. None of the information collected correlates with the future movement of the stock. If it did, everyone would have abandoned the remaining systems, and the stock market would no longer be a crap-shoot. The direction the stock moves is the aggregation of belief that it is either under-valued or over-valued at a particular point in time, as well as the fear-in-action of those who choose not to participate, even though they possess the means to purchase the stock and the belief that they should purchase the stock.

Each individual's proclivity to make or not make a purchase decision can be viewed as their Sentiment. In this case, Sentiment is defined as an individual's positive or negative view of a given proposition. The proposition can be defined as whether to purchase a given stock or other financial instrument, vote for a given person, develop a given product, or find someone guilty or innocent. Sentiment can also mean the proclivity to refrain from a certain transaction, whatsoever, or to even oppose a proposition (e.g., oppose a person's candidacy).

Assuming that the aggregate decisions of the actors in a given field of endeavor are average, white and Gaussian, repetitively acquiring the Sentiment of a statistically significant segment of the population should have significant analytical and predictive capability. Users would essentially turn themselves into measurement devices. The devices can be ranked and weighted in order of their effectiveness. To the extent that intuitive, conscious, unconscious, and reactive thinking, aggregated over the population, or a significant set of the population, can be correlated to mass behavior in a complex system, sentiment can be used to predict such outcomes.

Such a system could be implemented on a smart-phone, laptop, television, desk-top computer, vehicle communication system, or any other electronic apparatus to which an end user has repeated access. The tool could be set up, using gaming theory, to encourage both long-term, repetitive usage, and to encourage the end users to bring their Sentiment into line with the collective Sentiment. In this way, such a tool would solve three important problems at once.

First, the tool could identify users who truly have predictive capability within a certain field of endeavor. Second, the tool would give a real-time prediction of the collective Sentiment concerning an outcome. This would be very powerful in certain fields, such as picking stocks, products for the product development process, etc. Essentially, any field of endeavor which depends on the aggregate Sentiment of a population could be predicted in real time. Last, the tool would develop an individual's Sentiment so that it mimicked the actual outcome of events, and, hopefully, the collective Sentiment. In this way, it would remove an inhibition to action. For example, many people refrain from purchasing stocks because they have fear that their decision is wrong.

The present invention differs, substantially, from the prior art, on sentiment, that is currently in existence. There is substantial prior art concerning sentiment, as it relates to the stock market. The first class (705) of prior art is related to the measurement or quantification of stock market sentiment.

U.S. Pat. No. 7,966,241, by named inventor R. Nosegbe, is entitled, “Stock method for measuring and assigning precise meaning to market sentiment” (“Nosegbe 241”). “The present invention relates to a standard quantification method for assigning precise meaning to the feeling, or market sentiment, of a company stocks and the stock market as a whole. More specifically, the present invention works by calculating such elements as a Sentiment Index and a Sentiment Quotient so that the intensity and overall sentiment of a stock in relation to transparent price valuation and other factors can ultimately be studied through an interface called Market Sentiment Curve.” U.S. Pat. No. 7,966,241 at p. 9. Further, “[t]he present invention provides objective standards, methods, and processes, and an interface—the Market Sentiment Curve—for quantifying and assigning précised [sic] meaning to the feeling, or market sentiment, of a company stocks [sic] and the stock market as a whole.” I.bid.

Nosegbe 241 includes the following design elements: a specific mathematical formula for calculating Sentiment Index at a point in time; a specific mathematical formula for calculating the Sentiment Quotient at a point in time; a specific mathematical formula for the change in Sentiment Quotient over time; and formulas to calculate whether sentiment indicates a bubble, exuberance, or lethargy. These formulas use objective measurements to calculate sentiment, including, but not limited to, Earnings per Share (“EPS”), Price per Share (“PPS”), expected return (“r”), risk free premium (“rf”), and average market return (“mr”). The formulas are used to create a Sentiment Curve, which is used to make investment decisions. The patent claims methods to calculate Sentiment Index, Sentiment Quoteient, Sentiment Curve, etc., all from objective data.

The invention which is the subject of this application differs from Nosegbe 241 in several important ways. This application only examines some material facets. First, and most importantly, the present invention defines instantaneous sentiment as the current feeling a person has towards a dependent variable, such as which direction an individual stock price will be moving. The instantaneous sentiment from a single user is a Boolean number: i.e., the user can only have positive or negative sentiment. In Nosegbe, the inventor is trying to take numerous independent variables and then calculating a dependent variable called sentiment. Second, the present invention attempts to drive repetitive sentiment expression, so that the current aggregate sentiment expression can be compared with dependent variables of interest. Third, the present invention uses gaming theory in order to encourage repetitive use. The repetitive use allows the system to train the user to be more accurate, when it comes to predicting dependent variables related to sentiment. Fourth, the present invention, compares individual users sentiment measurements against dependent variables, in addition to comparing the aggregate sentiment. Fifth, the present invention is intent on quantifying and correlating sentiment, which is defined as a subjective measurement. Nosegbe 241 tries to make a sentiment calculation from numerous objective measurements. In other words, Nosegbe 241 uses static formulas to define a static surface in an attempt to model a dynamic system.

U.S. Pat. No. 7,996,210, by named inventors N. Godbole et. al, and assigned to the Research Foundation of the State University of New York, is entitled, “Large-scale sentiment analysis” (“Godbole 210”). Godbole 210 discloses a method for determining sentiment associated with an entity. The entity is not necessarily a stock or a stock market. Essentially, Godbole 210 comprises, inter alia, a plurality of texts associated with the entity, labeling seed words in the plurality of texts as positive or negative, and determining a score estimate for the plurality of words based on the labeling. From a high-level, algorithmically, this invention (1) creates a seed word list; (2) identifies synonyms and antonyms for each seed word; (3) assigns a polarity with each of a set of seed words, synonyms and antonyms; (4) determine a preliminary score for each text entry; (5) conduct a sensitivity analysis to the preliminary score; (6) record scores which meet certain pre-defined criteria; (7) convert scores to z-scores; and (8) discard ambiguous text.

The present invention differs from Godbole 210 in several crucial ways. First, the present invention takes, directly, a Boolean sentiment measurement from each individual end user. The invention in Godbole 210 uses data-mining techniques to see if the current published information on a particular topic is positive or negative. Second, the present invention is working with non-transformed data. Godbole 210 is calculating sentiment from transformed data. Third, the present invention drives the end user to provide repetitive sentiment data. Godbole 210 does not. Fourth, the present invention drives the end user to provide more and more accurate sentiment data. Godbole 210 does not. Fifth, the present invention works directly with data provided by the measurement device (i.e., the end user). Godbole 210 uses data-mining, relying on the opinions of the data-miners to correctly interpret the sentiment provided in the relevant text. As a result, any correlation performed with Godbole 210 will have a layer of data transform error, which will lower the overall possible correlation obtainable with the invention. This error does not exist in the present invention.

Finally, Godbole 210, at best, summarizes only published sentiment, which tends to be inaccurate due to several inherent constructs. For example, published sentiment is biased, as most publishers write in an attempt to defend a vested position, or to sway others to adopt a position. Published sentiment is a relatively small, self-selected sample set. The method that Godbole 210 employs assumes that published sentiment does not change over time. Last, Godbole 210 does not authenticate the genuineness of the sentiment, nor does it validate that the sentiment correlates with any meaningful dependent variable.

A more stock-market specific sentiment invention is U.S. patent application Ser. No. 11/110,291. U.S. patent application Ser. No. 11/110,291, by named inventor J. Rader, assigned to AIM Holdings LLC, is entitled, “Method and system for conducting sentiment analysis for securities research” (“Rader 291”). The present invention seeks to use one or more text data-mining methods to extract market sentiment data from databases. The databases from which the data can be collected include, but are not limited to, industry publications, technical publications, financial news web sites, analyst reports, general newspapers, blogs, chat rooms, company-specific message boards, user groups, and stock market measurements, such as price. The user interface of this tool will be tailorable, so that the end user can select the sources to be selected for analysis, as well as whether the analysis is for a specific stock, a market segment, or a market, in general. The sentiment analyzer would categorize data sources as either Tier 1 or Tier 2, and graph a representation of sentiment vs. stock prices and analyst ratings.

Rader 291 would be an internet-based tool, comprised of the following design elements: a content mining search agent; a specially trained sentiment analyzer, an archive database of mined data; and a user interface program that allows a user to conduct direct searches and view results. “The text gathered by the content mining search agent is analyzed by a natural language sentiment analyzer.” Rader 291 at 11. The sentiment analyzer discerns the topic of each data entry and determines whether such data represents a positive or negative view of the company. The sentiment analyzer would assign weighted scoring to the relevant raw textual data. The data-mining engine would be created such that it would automatically query the desired databases at pre-defined intervals.

The present invention differs from Rader 291 in much the same way as it differs from Godbole 210. First, the present invention takes, directly, a Boolean sentiment measurement from each individual end user. The invention in Rader 291 uses data-mining techniques to see if the current published information on a particular topic is positive or negative. Second, the present invention is working with non-transformed data. Rader 291 is calculating sentiment from a test analyzer, transformed data. Third, the present invention drives the end user to provide repetitive sentiment data. Rader 291 does not. Rader 291 merely allows the user to select which sources of “sentiment” will be analyzed in the data analyzer. Fourth, the present invention drives the end user to provide more and more accurate sentiment data. Rader 291 does not. Fifth, the present invention works directly with data provided by the measurement device (i.e., the end user). Rader 291 uses data-mining, relying on the embedded logic in the text analyzer to correctly interpret the sentiment provided in the relevant text. As a result, any correlation performed with Rader 291 will have a layer of data transform error, which will lower the overall possible correlation obtainable with the invention. This error does not exist in the present invention.

U.S. Pat. No. 7,185,065, by named inventors D. Holtzmann, et. al., is entitled, “System and method for scoring electronic messages” (“Holtzmann 065”). Holtzmann 065 discloses a method for computing a Sentiment score, which can be used in conjunction with stocks. The Sentiment score, “measures the degree to which a message exhibits positive or negative sentiment. The definition and measurement of positive and negative sentiment may change from product to product, since the way people convey their opinions is very different depending on the subject being evaluated. For example, in the financial world, positive sentiment may be measured by detecting ‘buy’ signals from the author. Negative sentiment may be measured by detecting ‘sell’ signals.” Holtzmann 065 at 27. Holtzmann does not disclose any direct user input (i.e., asking the user for positive or negative input).

The present invention differs from Holtzmann 065 in much the same way as it differs from both Rader 291 and Godbole 210. First, the present invention takes, directly, a Boolean sentiment measurement from each individual end user. The invention in Holtzmann 065, again, uses data-mining techniques to see if the current published information on a particular topic is positive or negative. Second, the present invention is working with non-transformed data. Holtzmann 065, again, is calculating sentiment from a test analyzer, which is transformed data. Third, the present invention drives the end user to provide repetitive sentiment data. Holtzmann 065, like Rader 291 and Godbole 210, does not. Holtzmann 065 merely allows the user to select which sources of “sentiment” will be analyzed in the data analyzer. Fourth, the present invention drives the end user to provide more and more accurate sentiment data. Holtzmann 065 does not. Fifth, the present invention works directly with data provided by the measurement device (i.e., the end user). Holtzmann 065 uses data-mining, relying on the embedded logic in the text analyzer to correctly interpret the sentiment provided in the relevant text. As a result, any correlation performed with Holtzmann 065 will have a layer of data transform error, which will lower the overall possible correlation obtainable with the invention. This error does not exist in the present invention. As in the case of Godbole 210 and Rader 291, any solution that automatically screens publications for sentiment expressions, while making no effort to qualify accuracy, runs the risk of being misled.

Additional prior art concentrates on collecting stock market sentiment directly from an end user, and weighing the input received from the end user. U.S. patent application Ser. No. 11/644,873, by named inventors O. Rossen, assigned to GridStock, Inc., is entitled, “Investor sentiment barometer” (“Rossen 873”). The Rossen 873 discloses a method for determining the collective sentiment of users towards stocks. Specifically, “[a] method comprising the steps of supplying an interactive environment through which a plurality of financial system users can express their sentiment towards a predefined stock, analyzing the users' sentiment expressions in order to deduce the users' sentiment towards the predefined stock and supplying the deduced users' sentiment towards the predefined stock.” Rossen 873 at 1. This application discloses a bar-line Investor Sentiment Barometer, which has positive sentiment at one end and negative sentiment at the other end. In one embodiment, the invention takes investor sentiment via text search engine and data-mining techniques, from chat rooms. In another embodiment, the invention takes investor sentiment from voice recognition software and data-mining techniques from a phone or voice-based system.

Rossen 873 claims, “A computer-implemented method comprising: supplying an interactive environment through which a plurality of financial system users can express their sentiment towards a predefined stock; analyzing the users' sentiment expressions in order to deduce the users' sentiment towards the predefined stock; and supplying the deduced users' sentiment towards the predefined stock.” Rossen 873 at 9. It further claims the above referenced invention, “wherein the deduced users' sentiment towards the predefined stock is supplied as an investor sentiment barometer.” I.bid. at p. 9, Claim 4. Additionally, Rossen 873 adds the above referenced invention, “wherein the step of analyzing the users' sentiment expressions comprises using users' past sentiment expressions regarding predefined stock.” I.bid. at p. 9, Claim 10. Lastly, Rossen 873 finishes by claiming, “A computer-implemented method, comprising: accessing an interactive environment through which a plurality of financial system users express their sentiments towards at least one stock; and analyzing the sentiment expressions of the financial system users and deducing the users' weighted sentiment towards at least one stock” (emphasis added). I.bid. at p. 9, Claim 12. Rossen 873 adds, in Claim 19, “wherein the step of analyzing the sentiment expressions of the financial system users comprises using users' past sentiment expressions regarding the at least [sic] on stock.”

Rossen 873 differs substantially from the present invention in a number of ways. Some of the most salient points are provided, herein. First, Rossen 873 does not seem to identify how sentiment would be useful. The present invention both (1) finds highly correlated users whose sentiment better predicts dependent variables of future events; and (2) trains users to be highly correlated users. Rossen 873 envisions using only financial experts in order to measure Sentiment, without ever correlating whether or not they are more accurate than the general public. The present input would be a stand-alone application which would allow the general public to use the tool, and contains a facility to correlate the sentiment data in order to identify the most accurate users, regardless of their field of profession. Rossen 873 only discloses financial field uses. The present invention has uses beyond financial fields. Rossen 873 takes sentiment from voice-recognition based system or from text engines. The present invention is designed to accept a Boolean data value (e.g., a plus or minus) input from the end-users electronic device. The electronic device can be almost any useful tool, such as a smartphone, laptop, or cable TV system. Therefore, although Rossen 873 may take in some Boolean input, it is not limited to Boolean input. The present invention limits sentiment to repetitively acquired Boolean input from end user electronic devices.

Rossen 873 discloses a passive tool. The user may use the tool. The present invention drives the end-user to provide sentiment measurements on dependent variables by using gaming theory, such as giving heavy users more contents and option, weighing heavy users more than light users, inter alia. Rossen 873 is concerned with the users' past sentiment, and does not disclose any method or intent to time-segment the sentiment provided by its users. The present invention is most concerned with new sentiment measurements, and also correlates sentiment based off of time segment. In this way, sentiment can be compared to a dependent variable over time, and the freshest sentiment can be used to provide a prediction of the current direction of the dependent variable in question.

### SUMMARY OF THE INVENTION

For the sake of this invention, a Sentiment Measurement is an end-user making a positive or negative assessment on the direction of a dependent variable. In other words, the Sentiment Measurement is a Boolean value. The dependent variable can be any complex variable, which lends itself to measurement or prediction by humans, such as stock price, the direction of the stock price is heading (derivative of stock price), the likelihood of success of a product, etc. The present invention is an apparatus and method to (1) repetitively measure individual Sentiment; (2) aggregate all of the individual Sentiments into a collective Sentiment; (3) correlate the sentiment data versus a pre-defined dependent variable, such as what direction an individual stock's price is heading; (4) present the data to the end-users; (5) encourage repetitive use; (6) identify end-users who best predict future behavior of the dependent variable(s); and (7) improve the end-user's Sentiment accuracy with repetitive use.

The invention is comprised of, among other design elements, an end-user device, a central processing unit, a data storage medium, a means of communicating between the end-user device and the central processing unit, software resident on the end-user device which prompts repetitive sentiment measurement, software resident on the central processing unit end which aggregates sentiment from all users and correlates individual sentiment to actual performance of a predefined dependent variable, and the input/output software to communicate between the two ends.

The end-user device can be a smartphone, personal digital assistant, stand-alone mobile-data-terminal, laptop computer, desktop computer, gaming system (e.g., PS3), cable TV system, or other electronic device with which the end user interacts often. The communication medium can be a cellular connection, the internet, radio frequency, telephone, cable modem, or any other method to transmit and receive communication between the end-user device and the central processing unit. The central processing unit can be provided in a cloud-based fashion, or it can be a tangible, physical central processing unit resident at a central server location.

The invention would load application software on the end-users electronic device that would, inter alia, (1) allow the end user to make sentiment measurements; (2) remind the end user to make repetitive sentiment measurements; (3) show the end user aggregations of data concerning dependent variables of interest; (4) show the relative accuracy of the user in predicting the dependent variables versus the participating population, in general; (5) show the user the needed milestones to unlock additional information and analysis from the data aggregation; and (6) show the user's current level of expertise.

### BRIEF DESCRIPTION OF THE DRAWINGS

FIG. 1 shows a high-level communication block diagram of this invention.

FIG. 2 shows a high-level flow chart of the receive portion of the software stack.

FIG. 3 shows a high-level flow chart of the processing of the received communication at the server/central processing unit.

FIG. 4 shows a high-level flow chart of the send portion of the software stack.

FIG. 5 shows a high-level flow chart of the request function for the user's applications.

FIG. 6 shows a high-level flow chart of the receive function on the end user's device.

FIG. 7 shows a high-level flow chart of the user sending sentiment to the Central Processing Unit.

### DETAILED DESCRIPTION OF THE PREFERRED EMBODIMENTS

The description and examples used herein, to described the current preferred embodiment or best mode, are used to illustrate the present invention and do not, in any way, limit the scope of the invention. Broadly speaking, the present invention is a method and apparatus to aggregate sentiment data from end users and use the data aggregations to correlate the results of a pre-defined dependent variable.

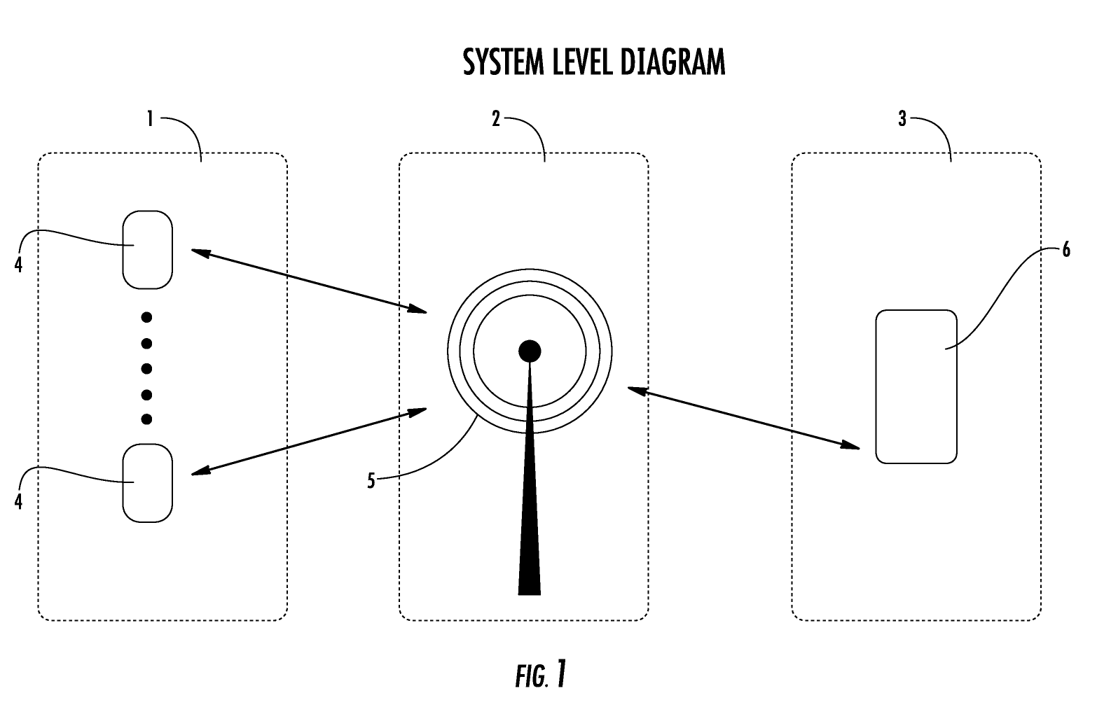

FIG. 1 shows a high level block diagram of the interaction of the hardware which enables the methods of the present invention. There is User Application part 1, a Communication part 2, and a Central System part 3. The User Application part 1, is comprised of a plurality of individual end-user electronic devices 4. The end-user electronic devices 4 include, but are not limited to, smartphones, mobile data terminals, laptop computers, gaming systems, cable TV systems, vehicle user interfaces, and stand-alone devices. Software enabling the method would communicate from the end-user electronic devices 4 via a Communication part 2. The Communication part 2 can be comprised of technologies including, but not limited to the internet, cellphone towers, radio frequency transmission, WiFi, or other communications means. FIG. 1 shows the communication being performed by a cellphone or radio frequency tower 5. The cellphone or radio frequency tower 5 then transmits the data to the Central System part 3. The Central System part can be made of technologies including, but not limited to, the cloud (Software as a Service), and server-based CPUs. FIG. 1 shows the Central System part being comprised of a central processing unit 6, which accepts communication from the end-user devices 4, via cellphone towers 5.

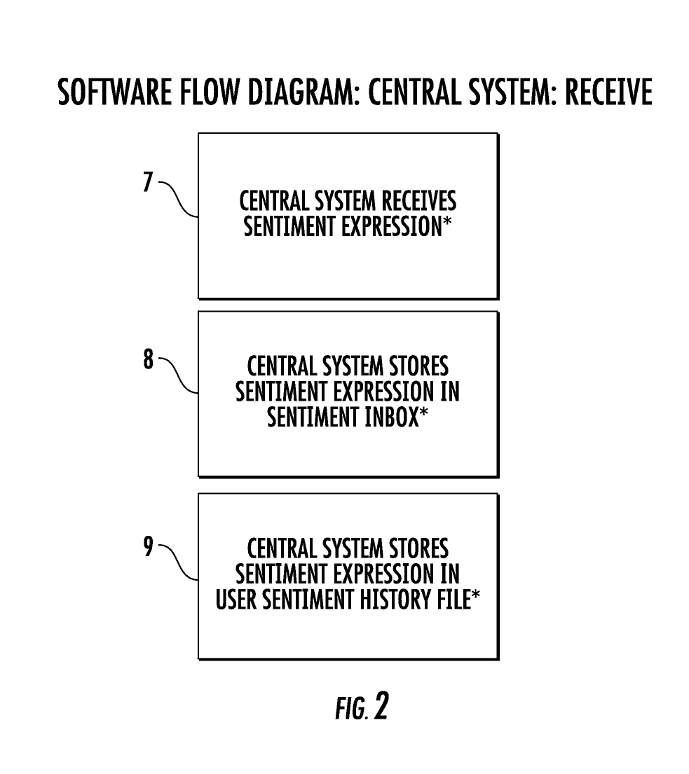

FIG. 2 shows a high-level flow-chart of the Central System receive functionality. The Central System receives Sentiment Measurements 7 from the end user. The Central System stores the Sentiment Measurement in a cached Sentiment Inbox 8. The Central System then, also, stores the Sentiment Measurement in the User Sentiment History File 9. The Sentiment Inbox and the User Sentiment History Files can be represented in a database program for computational ease.

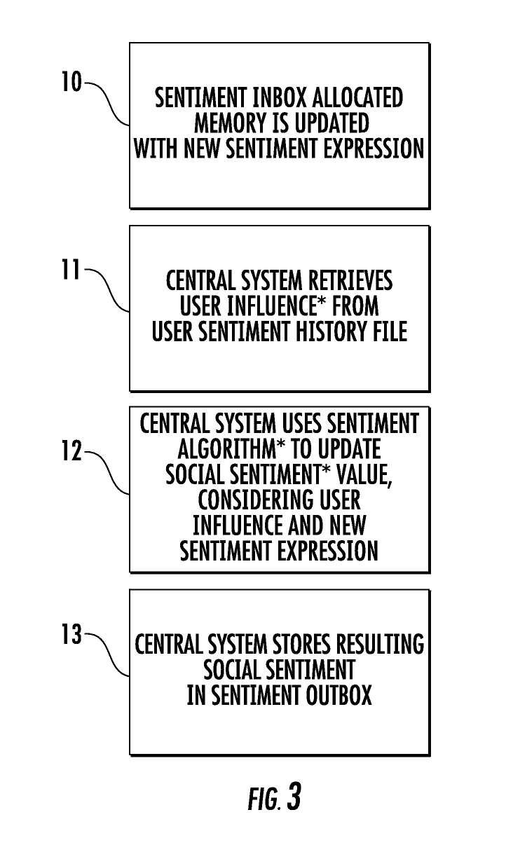

FIG. 3 shows a high-level flow-chart of how the Central System updates itself based on the user receive functionality 7. The Sentiment Inbox allocated memory is updated with the new Sentiment Measurement 10 (old sentiment records are not erased, but are rather stored and time-stamped). The Central System retrieves user influence from the User Sentiment History File 11. The Central System uses a sentiment algorithm to update aggregate sentiment value, called the Social Sentiment Value 12. The sentiment algorithm depends on the aggregation of the Sentiment Measurements provided by end-users, the time stamp, and the relative weighting of each end-user who has provided sentiment measurement. Last, the Central System stores the resulting Social Sentiment in the Sentiment Outbox 13.

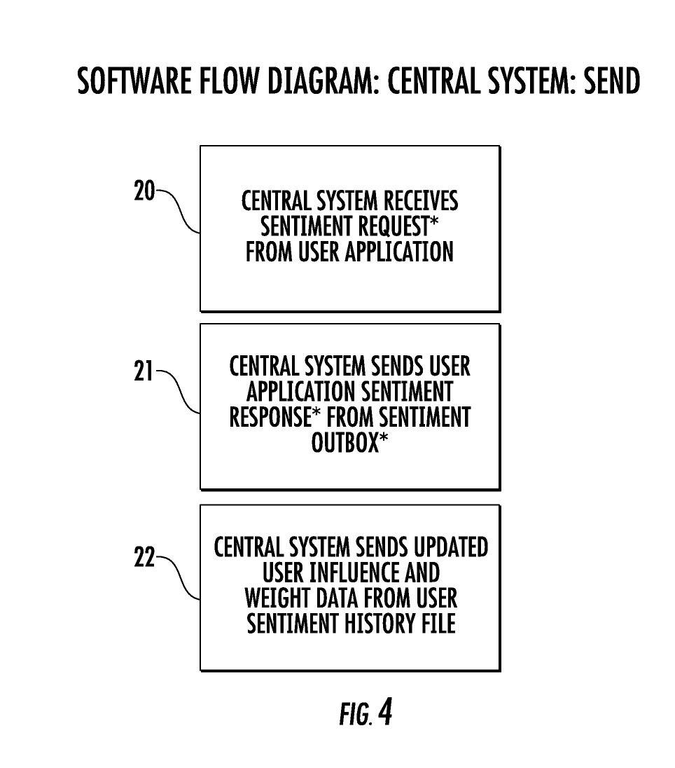

FIG. 4 shows a high-level flow-chart of the Central System send functionality. When the Central System receives a request to push data to the end-user 20, the Central System sends the end-user the application Social Sentiment response from the Central System Sentiment Outbox 21. The Central System also sends updated user influence and weight data to the user, from the User Sentiment History File 22.

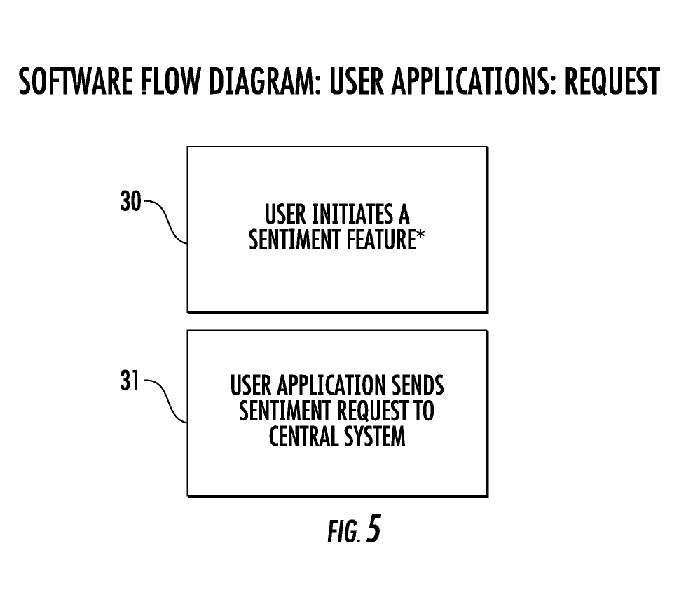

Likewise, in FIG. 5, the user initiates other user applications requests from the Central System, by initiating the request on the end-user's electronic device. The user initiates a sentiment feature 30. The user application then sends the sentiment request to the Central System 31.

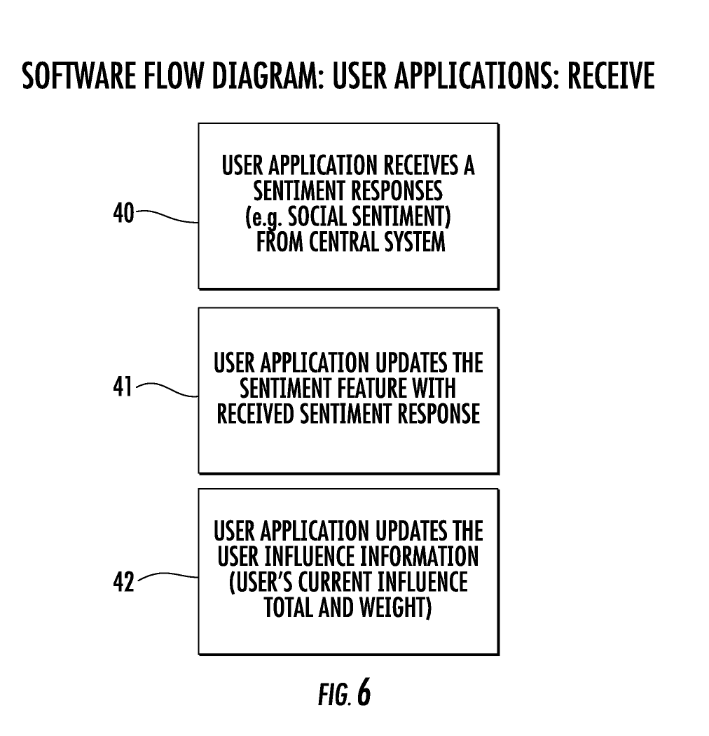

In FIG. 6, the user application resident on the end-user electronic device receives the requested data from the Central System. The user application receives the Social Sentiment form the Central System 40. The user application updates the sentiment feature with received sentiment response 41. The user application updates the user influence information 42, including the user's current influence total and weight.

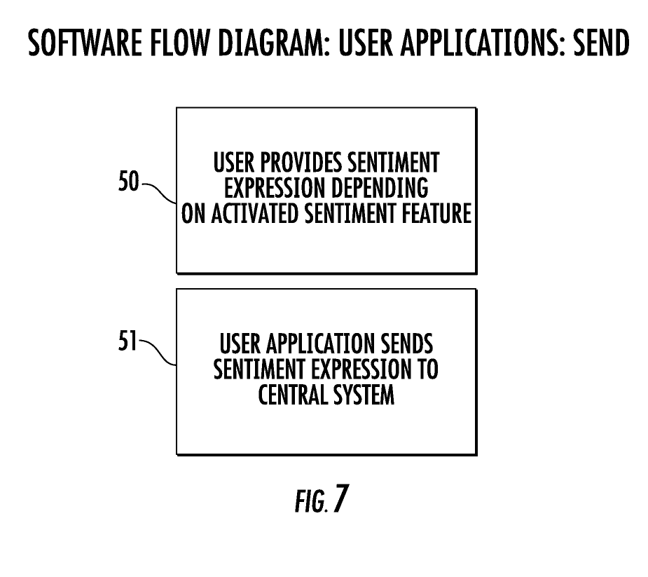

In FIG. 7, the user application send function is illustrated. The user provides Sentiment Measurements depending on activated sentiment feature 50 (e.g., in the financial services industry, this could be the Central System asking the user to provide a Sentiment Measurement for a particular stock, or, based off of the user's own usage patter, the application loaded on the end-user's electronic device could make this request). The user application sends the Sentiment Measurement to the Central System.

We claim:

1. A method and apparatus for capturing collective Sentiment, comprised of the following: a central processing unit; an end-user electronic device; a method of communicating between the end-user electronic device and the central processing unit; a method of obtaining an individualized Sentiment Measurement about a subjective field of endeavor by having end-users input data into the end-user electronic device; a method of aggregating the individual Sentiment measurements from a number of end users into a collective Sentiment; a method of creating an analysis of the resulting collection of collective Sentiment; a method of presenting the data analysis to the individual users and others; and a means of encouraging an end-user to provide long-term, repetitive individual Sentiment measurements.

2. The invention described in 1, in which the Sentiment Measurement is collected concerning one or more of the following: financial markets; the suitability or viability of a concept to be developed into a product; the suitability or viability of a concept to be developed into a movie or other moving picture with sound representation; the suitability or viability of a concept to be developed into a restaurant or other entertainment establishment; the electability, suitability, or viability of a candidate or proposition in an election; the outcome of a legal case; the outcome of a sporting event; and the outcome(s) of a games of chance.

3. The invention described in 1, in which the Sentiment Measurement is confined to a strictly Boolean value or data type.

4. The invention described in 1, in which the means for encouraging long-term, repetitive use utilizes gaming theory, unlocking new features and functions as the end-user achieves pre-established milestones concerning use, accuracy, or other goals.

5. The invention described in 4, in which the highest performing end-users are identified and monitored separately from the general population.

6. The invention described in 5, in which optional data representations are generated, based on the difference between the general population and the highest performing end-users.

7. The invention described in 6, in which the end-user can elect to publicly display their reputation.

8. The invention described in 1, in which an end-user can specify topics or queries to present to other users; and can define or limit the set of users from which the end-user's individualized Social Sentiment Value will be calculated.

9. The invention described in 1, in which the end-user electronic device is a cellphone, smart-phone, tablet, or similar hand-held, portable device.

10. The invention described in 1, in which the application uses a graphic-user interface (“GUI”) that contextualizes the data on a multi-dimensional, interlocking wheels, which are projected, flat, onto the screen of the end-user's electronic device, and which are used to display data arrangements including, but not limited to, arrays, groups, sub-groups, and classes.

11. The invention described in 10, in which multi-dimensional wheel is continuous, bringing the user back to the initial starting point if it is rotated sufficiently.

12. The invention described in 10, in which the size, content, and subject matter of each multi-dimensional wheel can be user-defined.

13. The invention described in 10, in which the multi-dimensional wheels are navigated through traditional computer interfaces such as a keyboard or mouse.

14. The invention described in 10, in which the end-user electronic device has a touch-screen interface.

15. The invention described in 14, in which the GUI can be directionally navigated, using the touch-screen, for each unique dimension of the multi-dimensional wheel.

16. The invention described in 14, in which the GUI can be navigated using one finger.

17. The invention described in 14, in which the user has to simultaneously press either two plus (“+”) signs or two minus (“−”) signs in order to register their Sentiment measurement.

18. The invention described in 16, in which GUI navigation is aligned with finger swipe direction.

19. The invention described in 1, in which the communications method is wireless, including, but not limited to, cellular, Wi-Fi, radio frequency, and Blue Tooth™.

20. The invention described in 1, in which the communications method relies on a wired connection, included, but not limited to, internet, intranet, VPN, and phone or cable modem.
